(19) United States
(12) Patent Application Publication
(10) Pub. No.: US 2017/0272835 A1
(43) Pub. Date: Sep. 21, 2017

(54) DECISION DEVICE FOR SWITCHING DIGITAL DATA PACKET STREAM, METHOD, AND NON-TRANSITORY COMPUTER READABLE STORAGE MEDIUM

(71) Applicant: YAHOO JAPAN CORPORATION, Tokyo (JP)

(72) Inventor: Junki OSANAI, Tokyo (JP)

(73) Assignee: YAHOO JAPAN CORPORATION, Tokyo (JP)

(21) Appl. No.: 15/444,707

(22) Filed: Feb. 28, 2017

(30) Foreign Application Priority Data
Mar. 18, 2016 (JP) 2016-054883

(51) Int. Cl. H04N 21/81; H04N 21/442; H04N 21/234

(52) U.S. Cl. CPC H04N 21/812; H04N 21/23424; H04N 21/44204

(57) ABSTRACT

A decision device for switching a digital data packet stream according to the present application includes an acquiring unit and a decision unit. An acquiring unit acquires, as feature information associated with a first digital data packet stream that is transmitted via an information and telecommunications network, the length of playback time in a case where the digital data packet stream is played back by rendering at a standard playback rate. A decision unit decides, on the basis of the length of the playback time acquired by the acquiring unit, a time position in which a playback target is switched temporarily from the first digital data packet stream to a second digital data packet stream.

### CROSS-REFERENCE TO RELATED APPLICATION(S)

The present application claims priority to and incorporates by reference the entire contents of Japanese Patent Application No. 2016-054883 filed in Japan on Mar. 18, 2016.

### BACKGROUND OF THE INVENTION

1. Field of the Invention

The present invention relates to a decision device for switching a digital data packet stream, a method, and a non-transitory computer readable storage medium having stored therein a computer program.

2. Description of the Related Art

In recent years, due to rapidly widespread use of the Internet and improvement of a distribution technology, a large variety of pieces of content can be browsed via the Internet. For example, many users browse video content, such as a movie, a drama, or the like, via the Internet.

In connection with the distribution of such video content, a technology for inserting advertisements into video content is proposed.

However, with the conventional technology, it is difficult to insert advertisements into the video content at appropriate playback positions. With the conventional technology, the position in which an advertisement is inserted is determined by, for example, a content provider. In this case, unless the insertion position of the advertisement is an appropriate position with respect to the video content, this results in a decrease in the usability of viewing users. Furthermore, although there is a method of manually inserting advertisements, if the number of pieces of video content becomes large, it is not practical to manually determine the insertion points of advertisements.

### SUMMARY OF THE INVENTION

It is an object of the present invention to at least partially solve the problems in the conventional technology.

A decision device for switching a digital data packet stream according to the present application includes an acquiring unit acquires, as feature information associated with a first digital data packet stream that is transmitted via an information and telecommunications network, the length of playback time in a case where the digital data packet stream is played back by rendering at a standard playback rate, and a decision unit decides, on the basis of the length of the playback time acquired by the acquiring unit, a time position in which a playback target is switched temporarily from the first digital data packet stream to a second digital data packet stream. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating an example of a decision process according to an embodiment;

FIG. 2 is a schematic diagram illustrating a configuration example of a decision system according to the embodiment;

FIG. 3 is a block diagram illustrating a configuration example of a decision device according to the embodiment;

FIG. 4 is a schematic diagram illustrating an example of a content storage unit according to the embodiment;

FIG. 5 is a schematic diagram illustrating an example of an insertion setting storage unit according to the embodiment;

FIG. 6 is a schematic diagram illustrating an example of a viewing state storage unit according to the embodiment;

FIG. 7 is a flowchart (1) illustrating the flow of a process performed by the decision device according to the embodiment;

FIG. 8 is a flowchart (2) illustrating the flow of a process performed by the decision device according to the embodiment;

FIG. 9 is a flowchart (3) illustrating the flow of a process performed by the decision device according to the embodiment; and

FIG. 10 is a block diagram illustrating an example of the hardware configuration of a computer that implements the function performed by the decision device.

### DETAILED DESCRIPTION OF THE PREFERRED EMBODIMENTS

A mode (hereinafter, referred to as an “embodiment”) for carrying out a decision device for switching a digital data packet stream, a method, and a non-transitory computer readable storage medium having stored therein a computer program according to the present invention will be described in detail below with reference to the accompanying drawings. The decision device for switching a digital data packet stream, the method, and the non-transitory computer readable storage medium having stored therein the computer program according to the present invention are not limited by the embodiment. Furthermore, each of the embodiments can be appropriately used in combination as long as the content of processes does not conflict with each other. Furthermore, in the embodiments below, the same components are denoted by the same reference numerals and an overlapping description will be omitted.

1. Example of a Decision Device

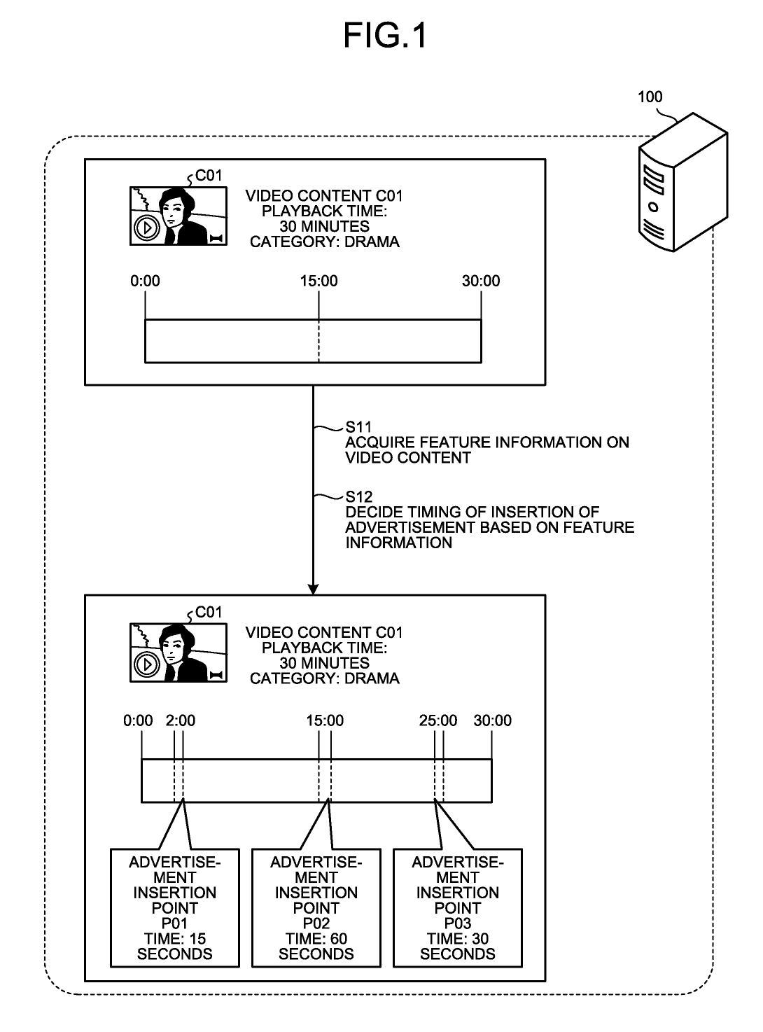

First, an example of a decision process according to the embodiment will be described with reference to FIG. 1. FIG. 1 is a schematic diagram illustrating an example of a decision process according to the embodiment. FIG. 1 illustrates an example in which a process of deciding, performed by a decision device 100 that performs a decision process according to the present embodiments, the timing in which advertisement is inserted (hereinafter, sometimes referred to as the “advertisement insertion point”) into video content that is provided via a network is performed.

The decision device 100 is a server device that holds video content that is used by a video distribution service. The video distribution service mentioned here is a service of distributing video content to a user who desires video content for a fee or for free. The video distribution service is provided via, for example, a video distribution site.

In the video content distributed from the video distribution service, advertisement may sometimes be played back before the video content is played back or during a playback. This is because an advertisement distribution request is included in the video content. Specifically, if the playback position of the video content reaches a predetermined timing (advertisement insertion point), the advertisement distribution request included in the video content is sent to an advertisement server. Then, the advertisement server that has received the advertisement distribution request distributes an advertisement to a terminal device that is playing back the video content. Consequently, in the predetermined timing at the time when the video content is being played back, the advertisement is played back instead of the video content (or due to an overlay).

At this point, in the video content distributed from the video distribution service, clear playback time is not commonly defined. Namely, in the video distribution service, pieces of video content each having various playback time are present in a mixed manner. Consequently, it is difficult to appropriately set the advertisement insertion point of the video content and, furthermore, the load applied to a setting person is increased if the advertisement insertion point is manually set to each of the pieces of the video content.

In contrast, because the decision device 100 sets the advertisement insertion point on the basis of the feature information on the video content, the decision device 100 appropriately sets the advertisement insertion point and reduces the load of the setting. In the following, an example of a decision process of the video content performed by the decision device 100 will be described along the flow of the process.

In the example illustrated in FIG. 1, it is assumed that the decision device 100 has accepted the submission of video content C01. For example, the video content C01 is submitted to the decision device 100 by a submitter who desires that the video content C01 be distributed in a video distribution service that is provided by the decision device 100.

If the video content C01 has been submitted, the decision device 100 extracts and acquires the feature information on the video content C01 (Step S11). For example, the decision device 100 acquires the playback time of the video content C01. In the example illustrated in FIG. 1, the decision device 100 acquires the feature information indicating that the playback time of the video content C01 is “30 minutes”.

Furthermore, the decision device 100 acquires, as the feature information on the video content C01, the category to which the video content C01 belongs. Here, the category of the video content is tag information that is attached in order to distinguish the pieces of the video content and is, specifically, the tag information, such as a “drama”, “music”, “animation”, a “movie”, or the like. The category of the video content is previously set by, for example, a submitter of the video content, an administrator of the decision device 100, or the like.

Then, the decision device 100 decides, on the basis of the acquired feature information on the video content C01, the advertisement insertion point that is the timing in which the advertisement is inserted into the video content C01 (Step S12).

At this point, it is assumed that the decision device 100 stores therein, in advance, the insertion setting information that serves as the standard of the advertisement insertion point for each of the pieces of the feature information. For example, the decision device 100 stores therein, in an associated manner with the playback time of the submitted video content, the position information (hereinafter, sometimes referred to as an “insertion reference point”) that serves as the standard of the insertion, such as information indicating the number of advertisement insertion points that are decided to be inserted in the playback position in the entire video content. Furthermore, the decision device 100 stores therein, in an associated manner with the playback time of the submitted video content, the information indicating how many advertisement insertion points are to be created regarding the video content.

In addition, the decision device 100 may also store therein the time information indicating how long the advertisement is to be inserted at the advertisement insertion point. Furthermore, the decision device 100 may also store therein these pieces of setting information not only for each of the pieces of the playback time of the video content but also for each category of the video content.

Then, when the decision device 100 decides the advertisement insertion point, the decision device 100 checks the acquired feature information on the video content C01 against the previously stored insertion setting information. For example, if the decision device 100 includes feature information indicating that the playback time of the video content C01 is “30 minutes” and the category is a “drama”, the decision device 100 refers to the insertion setting information associated with the subject feature information.

For example, of the playback time of the video content C01, the decision device 100 refers to the insertion setting information and decides to create a first advertisement insertion point P01 at the time zone of “5 to 15%”, a second advertisement insertion point P02 at the time zone of “45 to 55%”, and a third advertisement insertion point P03 at the time zone of “80 to 85%”. Furthermore, the decision device 100 refers to the insertion setting information and decides to create a command for a distribution request for an advertisement with the duration of “15 to 30 seconds” to the advertisement insertion point P01, decides to create a command for a distribution request for an advertisement with the duration of “45 to 60 seconds” to the second advertisement insertion point P02, and decides to create a command for a distribution request for an advertisement with the duration of “30 to 45 seconds” to the third advertisement insertion point P03.

For example, as illustrated in FIG. 1, regarding the video content C01, the decision device 100 decides to create the advertisement insertion point P01 at the position of “2:00” from the playback starting point. Furthermore, the decision device 100 decides to create the advertisement insertion point P02 at the position of “15:00” from the playback starting point. Furthermore, the decision device 100 decides to create the advertisement insertion point P03 at the position of “25:00” from the playback starting point. Furthermore, it is assumed that the decision device 100 decides that the time period for which the advertisement is played back at each point is “15 seconds”, “60 seconds”, and “30 seconds”. In this case, because the advertisements are inserted, the playback time of the video content C01 is extended from 30 minutes by an amount corresponding to the playback time of the advertisement.

Furthermore, regarding the advertisement insertion points decided in this way, the decision device 100 may also perform various kinds of adjusting processes after the video content C01 is actually distributed. For example, it is assumed that, if the advertisement is played back at the advertisement insertion point P01, the decision device 100 has observed that the deviation rate of the user from the advertisement (i.e., the deviation rate from the video content C01) is higher than a predetermined threshold. In this case, the decision device 100 adjusts the position of the advertisement insertion point P01 within the range of the ratio that is set to the insertion setting information. For example, by repeating the processes, the decision device 100 can decide the advertisement insertion point P01 at the position in which the deviation rate of the user from the advertisement is small, in other words, at an appropriate position.

As described above, the decision device 100 according to the embodiment acquires the length of the playback time of the subject video content as the feature information that is included in the video content that is provided via a network. Then, the decision device 100 decides, on the basis of the acquired length of the playback time, the timing in which an advertisement is inserted into the video content.

In this way, as the feature information on the video content, for example, the decision device 100 according to the embodiment decides the advertisement insertion point on the basis of the entire playback time of the video content. Consequently, a plurality of pieces of video content in each of which various kinds of playback time are present in a mixed manner, the decision device 100 can appropriately decide the position in which an advertisement is inserted in accordance with each of the pieces of the video content. Furthermore, according to the decision device 100, for example, for a user who views short video content, because the number of advertisements to be run is small and, furthermore, because an advertisement with a short time period is easily run, a decrease in the usability can be suppressed. Furthermore, because it is assumed that a user who views relatively long video content views the video content in a relaxed manner, the decision device 100 adjusts to insert a relatively long advertisement. Namely, with the decision device 100, because an advertisement is distributed by selecting a user who tends to view the advertisement with relatively long time period, such as the advertisement that exhibits the branding effect, the advertisement desired by an advertiser is distributed. As described above, the decision device 100 can insert an advertisement at an appropriate playback position of video content.

2. Configuration of the Decision System

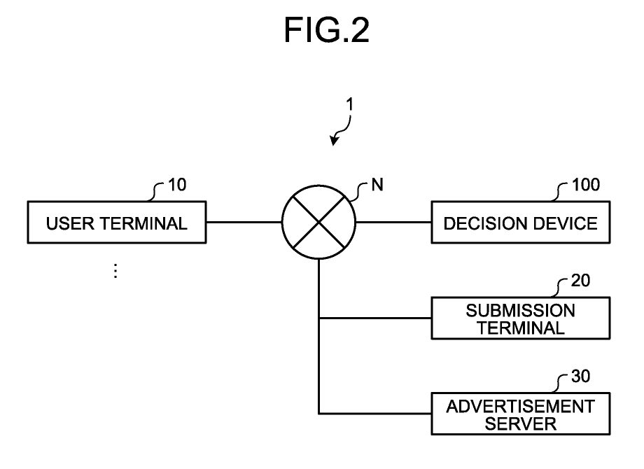

In the following, the configuration of a decision system 1 in which the decision device 100 according to the embodiment is included will be described with reference to FIG. 2. FIG. 2 is a schematic diagram illustrating a configuration example of the decision system 1 according to the embodiment. As illustrated in FIG. 2, the decision system 1 according to the embodiment includes a user terminal 10, a submission terminal 20, an advertisement server 30, and the decision device 100. These various kinds of devices are connected via a network N such that the devices can be communicated with each other in a wired or a wireless manner. Furthermore, in the decision system 1 illustrated in FIG. 2, a plurality number of the user terminals 10, a plurality number of the submission terminals 20, or a plurality number of the advertisement servers 30 may also be included.

The user terminal 10 is, for example, an information processing terminal, such as a desktop type personal computer (PC), a notebook type PC, a tablet type terminal, a mobile phone, a personal digital assistant (PDA), or the like. For example, the user terminal 10 accesses, in accordance with the operation performed by a user, a web server (in the embodiment, corresponding to the decision device 100) that provides video distribution sites or the like, whereby the user terminal 10 acquires a web page related to the desired video distribution service. Then, the user terminal 10 displays the acquired web page on a display device (for example, a liquid crystal display).

The submission terminal 20 is an information processing device that is used, in the video distribution service that is provided by the decision device 100, by a submitter who desires the video content to be distributed. The submission terminal 20 submits, in accordance with the operation performed by the submitter, the video content to the decision device 100.

The advertisement server 30 is a server device that distributes the advertisement that is played back in the video content. The advertisement server 30 receives an advertisement distribution request that is embedded in the video content and then distributes the advertisement to the user terminal 10 in response to the advertisement distribution request.

The decision device 100 is a server device that decides, as described above, the timing in which an advertisement is inserted in the video content. The decision device 100 decides, by using the feature information on the video content, such as the playback time, or the like, the timing in which the advertisement is inserted in the video content. Furthermore, the decision device 100 distributes, to the user terminal 10, the video content in which the timing of the insertion of the advertisement has been decided.

Furthermore, when distributing the video content or an advertisement, the decision device 100 and the advertisement server 30 can identify the user terminal 10 and specify the user terminal 10 that distributes video content or the advertisement. For example, identifying a user can be performed by including user identification information in a cookie that is sent and received between the web browser of the user terminal 10 and the decision device 100 or the advertisement server 30. However, the method of identifying a user is not limited to the above. For example, a program dedicated to the user terminal 10 may also be set and the user identification information may also be sent from the dedicated program to the decision device 100 or the advertisement server 30.

3. Configuration of the Decision Device

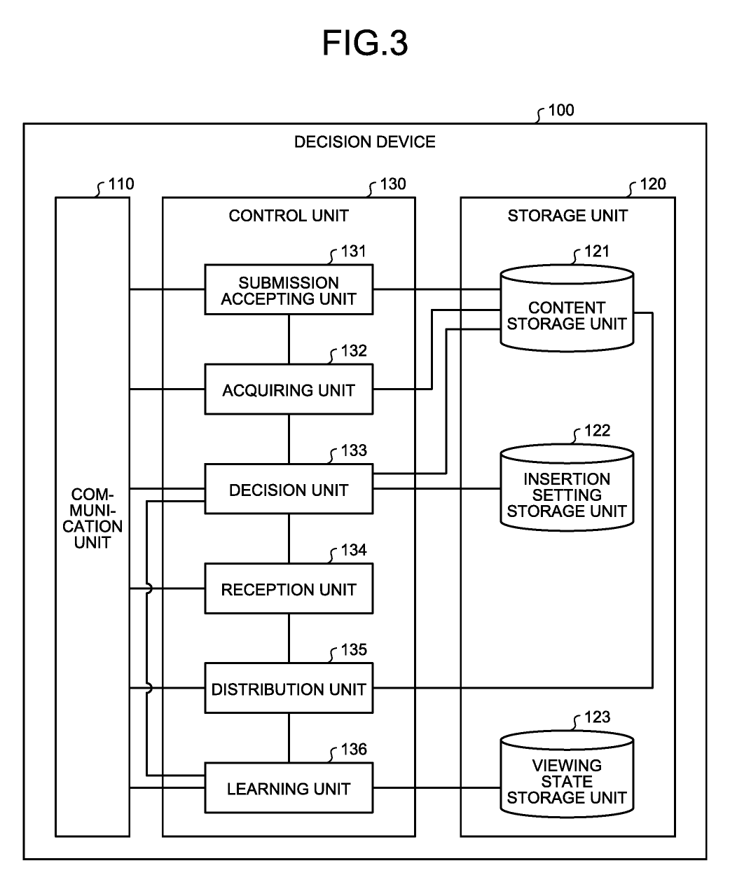

In the following, the configuration of the decision device 100 according to the embodiment will be described with reference to FIG. 3. FIG. 3 is a block diagram illustrating a configuration example of the decision device 100 according to the embodiment. As illustrated in FIG. 3, the decision device 100 includes a communication unit 110, a storage unit 120, and a control unit 130. Furthermore, the decision device 100 may also include an input unit (for example, a keyboard, a mouse, etc.) that accepts various kinds of operations from an administrator or the like who uses the decision device 100 or a display unit (for example, a liquid crystal display, etc.) that is used to display various kinds of information.

About the Communication Unit 110

The communication unit 110 is implemented by, for example, a network interface card (NIC), or the like. The communication unit 110 is connected to the network in a wired or a wireless manner and sends and receives information to and from the user terminal 10 or the submission terminal 20 via the network N.

About the Storage Unit 120

The storage unit 120 is implemented by, for example, a semiconductor memory device, such as a random access memory (RAM), a flash memory, and the like or implemented by a storage device, such as a hard disk, an optical disk, or the like. The storage unit 120 includes a content storage unit 121, an insertion setting storage unit 122, and a viewing state storage unit 123.

About the Content Storage Unit 121

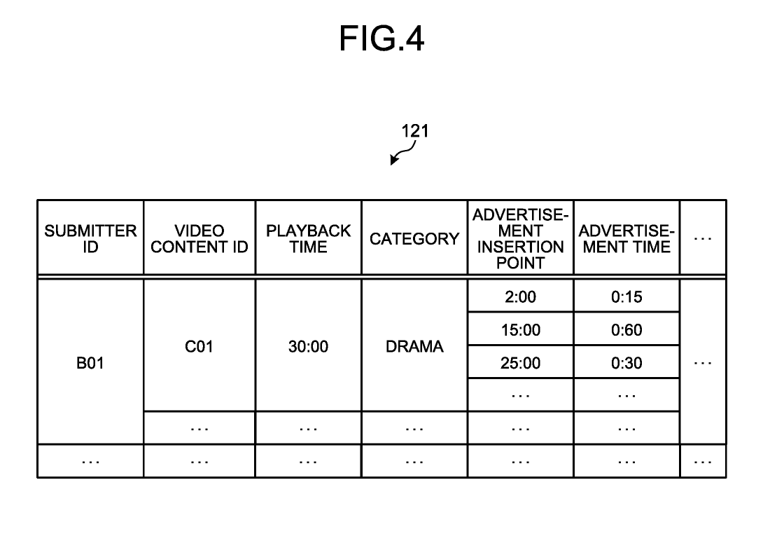

The content storage unit 121 stores therein information related to the video content that is submitted from the submission terminal 20. Here, FIG. 4 illustrates an example of the content storage unit 121 according to the embodiment. FIG. 4 is a schematic diagram illustrating an example of the content storage unit 121 according to the embodiment. As illustrated in FIG. 4, the content storage unit 121 has items, such as the “submitter ID”, the “video content ID”, the “playback time”, the “category”, and the “advertisement time”.

The “submitter ID” indicates identification information for identifying a submitter or the submission terminal 20. The “video content ID” indicates identification information for identifying the video content submitted from a submitter to the decision device 100.

Furthermore, in a description below, the identification information illustrated in FIG. 4 may sometimes be used as reference numeral. For example, the submitter identified by a submitter ID “B01” may sometimes be referred to as the “submitter B01” and the video content identified by a video content ID “C01” may sometimes be referred to as the “video content C01”.

The “playback time” indicates the playback time (the length of the gauge) of video content. The “category” indicates the category of video content.

The “advertisement insertion point” indicates the timing in which an advertisement is inserted. For example, as illustrated in FIG. 4, the advertisement insertion point is indicated by the time that indicates the playback position of the video content is inserted. The “advertisement time” indicates a period of time of an advertisement distributed at the advertisement insertion point. Furthermore, the advertisement insertion point and the advertisement time are decided by the decision device 100 and then stored in the content storage unit 121. Consequently, at the submission timing of the video content, information does not need to be stored. Furthermore, the advertisement insertion point and the advertisement time may appropriately be updated by the decision device 100.

Namely, in the example illustrated in FIG. 4, the submitter B01 identified by the submitter ID “B01” submits the video content C01 identified by the video content ID “C01”. Furthermore, the example illustrated in FIG. 4 indicates that the playback time of the video content C01 is “30 minutes” and the category is a “drama”. Furthermore, the example illustrated in FIG. 4 indicates that, in the video content C01, advertisements are inserted at the timing of “2 minutes”, “15 minutes”, and “25 minutes” and the advertisement time is “15 seconds”, “60 seconds”, and “30 seconds”.

Furthermore, the data itself on the video content that is actually distributed to the user terminal 10 may also be stored in a predetermined storage server that is separately provided from the decision device 100. In this case, on the basis of the video content ID stored in the content storage unit 121, the decision device 100 specifies the video content stored in an external storage server. Then, the decision device 100 controls the storage server such that the specified video content is distributed to the user terminal 10.

About the Insertion Setting Storage Unit 122

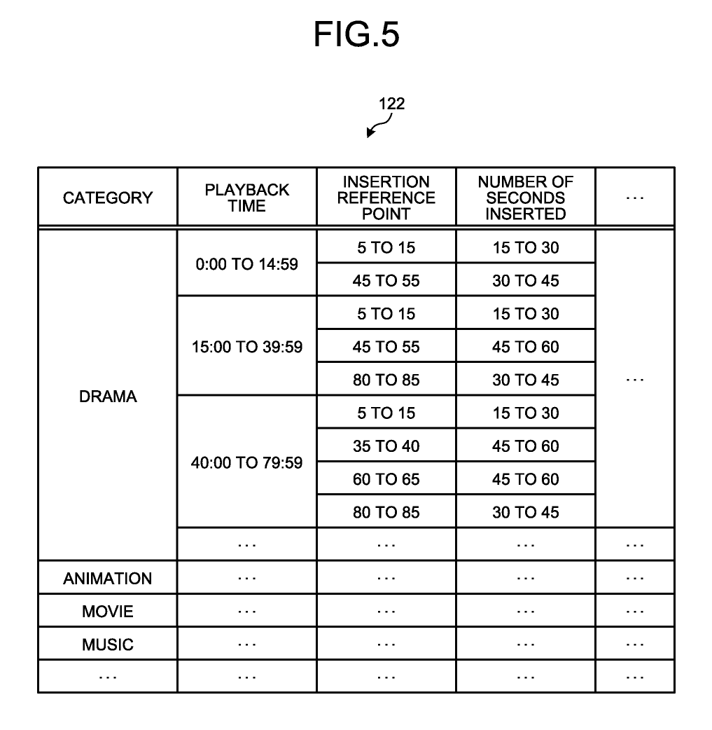

The insertion setting storage unit 122 stores therein the setting related to the timing in which an advertisement is inserted in video content. Here, FIG. 5 illustrates an example of the insertion setting storage unit 122 according to the embodiment. FIG. 5 is a schematic diagram illustrating an example of the insertion setting storage unit 122 according to the embodiment. The example illustrated in FIG. 5, the insertion setting storage unit 122 has items, such as the “category”, the “playback time”, the “insertion reference point”, and the “number of seconds inserted”.

The “category” and the “playback time” are the same items as those illustrated in FIG. 4. The “insertion reference point” indicates the information serving as the standard at the time when an advertisement insertion point is created. In the example illustrated in FIG. 5, it is assumed that the insertion reference point is indicated at a percentage of the playback position of the video content. For example, if the information on the item of the insertion reference point is “5 to 15”, this indicates that an advertisement insertion point is created at the position of “5 to 15%” of the playback position of the video content. The “number of seconds inserted” indicates the number of seconds of the advertisement to be run instead of the video content at the advertisement insertion point.

Namely, in the example illustrated in FIG. 5, for the video content in which the category is a “drama” and the entire playback time is “0 to 14 minutes and 59 seconds”, an advertisement insertion point is to be created at two positions, i.e., the position of “5 to 15%” and at the position of “45 to 55%”, which is the standard. Furthermore, the example illustrated in FIG. 5 indicates that the length of the advertisement to be run at each of the advertisement insertion points is decided to be “15 to 30 seconds” and “30 to 45 seconds”.

Furthermore, for the video content in which, for example, the category is a “drama” and the entire playback time is “15 minutes to 39 minutes and 59 seconds”, an advertisement insertion point is to be created at three positions, i.e., the position of “5 to 15%”, the position of “45 to 55%”, and the position of “80 to 85%”, which is the standard. Furthermore, the example illustrated in FIG. 5 indicates that the length of the advertisement to be run at each of the advertisement insertion points is decided to be “15 to 30 seconds”, “45 to 60 seconds”, and “30 to 45 seconds”.

About the Viewing State Storage Unit 123

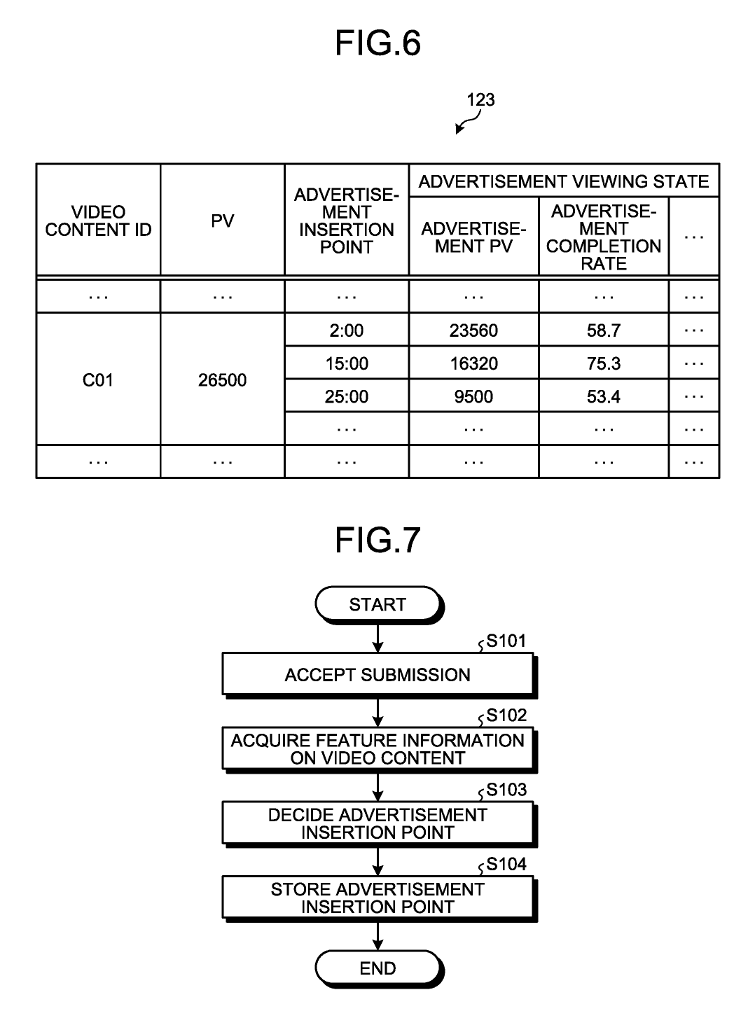

The viewing state storage unit 123 stores therein information related to the viewing state of video content. Here, FIG. 6 illustrates an example of the viewing state storage unit 123 according to the embodiment. FIG. 6 is a schematic diagram illustrating an example of the viewing state storage unit 123 according to the embodiment. The example illustrated in FIG. 6, the viewing state storage unit 123 has items, such as the “video content ID”, the “PV”, the “advertisement insertion point”, and the “advertisement viewing state”. Furthermore, in the “advertisement viewing state”, the sub-items of the “advertisement PV”, the “advertisement completion rate”, and the like are included.

The “video content ID” corresponds to the same item as that illustrated in FIG. 4. The “PV” indicates the number of page views (PVs) of the video content. The “advertisement insertion point” corresponds to the same item as that illustrated in FIG. 4.

The “advertisement viewing state” indicates the viewing state of the advertisement that is inserted when the video content is being played back. The “advertisement PV” indicates the number of PVs of the advertisement. The “advertisement completion rate” indicates the number of times an advertisement is viewed to the end.

Furthermore, regarding the PV of an advertisement, for example, the standard of handling the PV may also previously be set by the decision device 100. For example, a user may sometimes end a display at the moment when the advertisement is displayed. Consequently, the administrator of the decision device 100 may also perform adjustment such that the advertisement PV is added when a portion equal to or greater than 50% of an advertisement is displayed for 1 second or more on the browser of the user terminal 10.

Namely, the example illustrated in FIG. 6 indicates that the PV of the video content C01 is “26,500” times and the advertisement insertion point is set to “2 minutes”, “15 minutes”, and “25 minutes”. Furthermore, the example illustrated in FIG. 6 indicates that, as the advertisement viewing state in “2 minutes”, the advertisement PV is “23,560” times and the advertisement completion rate is “58.7%”. Furthermore, the example illustrated in FIG. 6 indicates that, as the advertisement viewing state in “15 minutes”, the advertisement PV is “16,320” times and the advertisement completion rate is “75.3%”. Furthermore, the example illustrated in FIG. 6 indicates that, as the advertisement viewing state in “25 minutes”, the advertisement PV is “9,500” times and the advertisement completion rate is “53.4%”.

About the Control Unit 130

The control unit 130 is a (controller) and is implemented by, for example, a central processing unit (CPU), a micro processing unit (MPU), or the like, executing various kinds of programs (corresponding to an example of a decision program), which are stored in a storage device in the decision device 100, by using a RAM as a work area. Furthermore, the control unit 130 is a controller and is implemented by, for example, an integrated circuit, such as an application specific integrated circuit (ASIC), a field programmable gate array (FPGA), or the like.

As illustrated in FIG. 3, the control unit 130 includes a submission accepting unit 131, an acquiring unit 132, a decision unit 133, a reception unit 134, a distribution unit 135, and a learning unit 136 and implements or executes the function or the operation of the information processing described below. Furthermore, the internal configuration of the control unit 130 is not limited to the configuration illustrated in FIG. 3 but another configuration may also be used as long as the configuration in which the information processing, which will be described later, is used. Furthermore, the connection relation between the processing units included in the control unit 130 is not limited to the connection relation illustrated in FIG. 3 and another connection relation may also be used.

About the Submission Accepting Unit 131

The submission accepting unit 131 accepts the submission of video content from the submission terminal 20. Then, the submission accepting unit 131 associates the submitter ID that identifies a submitter, i.e., the submission source, with the video content ID and stores, in the content storage unit 121, the information related to the submitted video content.

About the Acquiring Unit 132

The acquiring unit 132 acquires various kinds of information. For example, the acquiring unit 132 acquires the feature information on video content. Specifically, as the feature information included in the video content provided via a network, the acquiring unit 132 acquires the length of the playback time of the video content.

Furthermore, as the feature information of video content, the acquiring unit 132 may also acquire the category of the video content. The acquiring unit 132 appropriately stores, in the content storage unit 121, the acquired feature information on the video content.

Furthermore, the acquiring unit 132 may also acquire setting information, i.e., the information related to the insertion setting, that is associated with both the playback time of the video content and the category of the video content and that serves as the standard of the timing in which an advertisement is inserted in the video content. The acquiring unit 132 appropriately stores, in the insertion setting storage unit 122, the acquired insertion setting information.

Furthermore, as the feature information on the video content, the acquiring unit 132 may also acquire the information related to the data that constitutes the video content. For example, the acquiring unit 132 acquires the information related to the soundtrack of the video content. Consequently, the acquiring unit 132 can specify, in the video content, the playback position in which the sound volume is relatively increased, the playback position in which the sound volume is relatively decreased, or the playback position in which the sound volume is muted.

Furthermore, the acquiring unit 132 may also acquire, as the feature information on the video content, the information related to a change in a scene (spot) in the video content. Specifically, the acquiring unit 132 acquires the information related to the pixels of the image constituting the video content. Consequently, the acquiring unit 132 can specify, in the video content, the playback position in which a change in a scene can be assumed, such as the playback position in which the state becomes darker or the playback position in which the state becomes brighter. Furthermore, as the information related to a change in a scene in the video content, the acquiring unit 132 may also acquire the information related to, for example, a change in a scene that is originally set in the video content. For example, if a chapter is previously set in the video content, the acquiring unit 132 may also acquire the subject information as the feature information.

Furthermore, regarding the video content in which the timing of the insertion of an advertisement has been decided by the decision unit 133, which will be described later, the acquiring unit 132 may also acquire the viewing state of a user who has viewed the video content. For example, the acquiring unit 132 may also acquire, as the viewing state, the viewing start rate, the completion rate, the book mark rate, or the like of the video content. Furthermore, the acquiring unit 132 may also acquire, as the viewing state, the advertisement PV inserted in the video content, the advertisement completion rate, or the like.

Furthermore, the acquiring unit 132 may also acquire, as the viewing state, the information, such as the time information obtained at the moment when the video content is selected by a user, the duration information on the video content viewed by a user, the information on the deviation rate from the video content, or the like.

Furthermore, the acquiring unit 132 may also acquire the information related to the user terminal 10 that serves as the distribution destination of the video content or the information on a user who uses the user terminal 10. For example, the acquiring unit 132 may also acquire the attribute information on gender, age, annual income, taste, place of residence, or the like of a user.

About the Decision Unit 133

The decision unit 133 decides on the basis of the length of the playback time acquired by the acquiring unit 132, the timing (advertisement insertion point) in which an advertisement is inserted in the video content. Furthermore, the decision unit 133 may also decide, for each of the timings in addition to the timing in which the advertisement is inserted in the video content, the playback time of the advertisement to be inserted.

Furthermore, the decision unit 133 may also decide, on the basis of the category of the video content acquired by the acquiring unit 132, the advertisement insertion point of the video content. As described above, the decision unit 133 refers to the insertion setting information that is the setting information associated with both the playback time of the video content and the category of the video content and that serves as the standard of the timing in which an advertisement is inserted in the video content and then decides the advertisement insertion point inserted in the video content.

In general, because the constitution of the video image in video content varies in accordance with the category, the position appropriate for the insertion of an advertisement is sometimes different. For example, if the category of the video content is a drama, there is a certain standard, such as a first advertisement is inserted at an introductory part (for example, at the position in the vicinity of 10% of the entire of the video image) of the video image, a second advertisement is inserted in the central part of the video image, and a third advertisement is inserted in the last part (for example, at the position in the vicinity of 80% of the entire of the video image) of a story. Furthermore, if the category of the video content is music (music video), there is a certain standard, such as an advertisement is inserted in an introductory part of the video image; however, inserting an advertisement in the middle of music is undesirable.

Thus, the decision device 100 decides the advertisement insertion point on the basis of the category in addition to the playback time, whereby the decision device 100 can insert an advertisement at the position that is further appropriate for the video content.

Furthermore, the decision unit 133 may also decide the advertisement insertion point by further using the feature information on the video content, in addition to the playback time or the category of the video content. For example, if the information related to the soundtrack of the video content is acquired by the acquiring unit 132, the decision unit 133 may also decide the advertisement insertion point of the video content on the basis of the information related to the soundtrack of the video content.

For example, the decision unit 133 specifies, in the playback position of the video content, the timing in which the sound is muted. Then, the decision unit 133 decides the muted timing as the advertisement insertion point. If the video content is muted during the playback, it is conceivable that the subject position is a break point as the content of the video image. Consequently, by deciding the advertisement insertion point at the mute position, the decision unit 133 can insert an advertisement without causing a feeling of strangeness for a user. Furthermore, the decision unit 133 does not always need to insert an advertisement at the mute position and may also insert an advertisement at the position in which, for example, the sound volume is relatively low compared with the other playback positions. Furthermore, the decision unit 133 may also insert, on the basis of a threshold of the absolute sound volume, an advertisement at the position in which the sound volume is lower than that of the subject threshold. Furthermore, the decision unit 133 may also insert an advertisement if the state of the predetermined sound volume is continued longer than the predetermined time period. For example, the decision unit 133 may also insert an advertisement if the mute state or the state in which the sound volume is low is continued in a predetermined time period or more.

Furthermore, if the information related to a change in a scene in the video content is acquired by the acquiring unit 132, the decision unit 133 may also decide, on the basis of the subject information, the advertisement insertion point of the video content. For example, as the information related to the change in the scene, if the information related to pixels of a video image constituting the video content is acquired by the acquiring unit 132, the decision unit 133 may also decide the advertisement insertion point on the video content on the basis of the information related to the pixels of the video image constituting the video content.

For example, the decision unit 133 specifies, from among the playback positions of the video content, the darker timing or the brighter timing. Then, the decision unit 133 decides the darker timing or the brighter timing as the advertisement insertion point. It is conceivable that, if the video content becomes darker or brighter during the playback, the subject position is a breakpoint scene as the content of the video image. Consequently, by deciding the advertisement insertion point at the position in which the video content becomes darker or brighter, the decision unit 133 can insert an advertisement without causing a feeling of strangeness for a user. Furthermore, the decision unit 133 does not always need to insert an advertisement at the position in which the video content becomes darker or brighter but the decision unit 133 may also insert an advertisement at the position of the video image having, for example, the pixel information on the pixels relatively close to darker or brighter than the other playback positions.

Furthermore, after the video content has been distributed and used by a user, the decision unit 133 may also decide the advertisement insertion point on the basis of the information acquired by the acquiring unit 132.

For example, the decision unit 133 may also update, on the basis of the viewing state of a user who has viewed the video content, the timing in which the advertisement is inserted in the video content. As an example, if the completion rate of the advertisement inserted in the video content in the viewing state is lower than the predetermined threshold, the decision unit 133 may also change the timing in which the advertisement has been inserted and newly decide the timing in which the advertisement is inserted in the subject video content.

Furthermore, if the insertion setting is learned by the learning unit 136, which will be described later, and the insertion setting is changed, the decision unit 133 may also update the advertisement insertion point of the video content in accordance with the change.

About the Reception Unit 134

The reception unit 134 receives a distribution request of the video content. Specifically, if the user terminal 10 accesses the video distribution site, the reception unit 134 receives a distribution request for the content (for example, a web page, etc.) related to the video distribution site. In other words, the reception unit 134 receives the distribution request related to still image thumbnails or video thumbnails displayed on the top page or the like in the video distribution site.

Furthermore, when, as a trigger, the video content has been selected by a user, the reception unit 134 receives the distribution request for the video content that is sent from the user terminal 10. The state in which the video content has been selected indicates that, for example, a still image thumbnail or a video thumbnail is clicked by a user. Namely, if the still image thumbnails or the video thumbnail is clicked by the user, the reception unit 134 receives the distribution request for the video content associated with the still image thumbnail or the video thumbnail.

About the Distribution Unit 135

The distribution unit 135 distributes the video content associated with the distribution request that is received by the reception unit 134. First, if an access to the video distribution site is performed by the user terminal 10, the distribution unit 135 distributes, to the user terminal 10, the still image thumbnails or the video thumbnails that serve as the index of the video content to be distributed.

Then, a still image thumbnail or a video thumbnail is clicked by the user, whereby the distribution unit 135 distributes the subject video content when a distribution request for the video content that is associated with the still image thumbnail or the video thumbnail is received.

Furthermore, as described above, the data itself of the content actually distributed does not need to be stored in the storage unit 120 according to the decision device 100. For example, by sending a control command to a predetermined external storage server, the distribution unit 135 may also distribute, to the user terminal 10, the content associated with the distribution request.

About the Learning Unit 136

The learning unit 136 performs a predetermined learning process on the basis of the viewing state acquired by the acquiring unit 132. For example, the learning unit 136 learns the insertion setting information on the basis of the completion rate of the advertisement that is inserted in the video content.

For example, the learning unit 136 learns the advertisement insertion point in which the completion rate of the advertisement is high in the video content with the same playback time or the same category. Then, the learning unit 136 reflects the learning and then changes the numerical value of the insertion reference point. For example, even if the video content in which the insertion reference point is set to at the rate of “5 to 15%” is distributed, if the completion rate of the advertisement on the basis of the subject insertion reference point is lower than the predetermined threshold, the learning unit 136 may also change the numerical value that serves as the subject insertion reference point. The learning unit 136 repeats the learning described above on the basis of, for example, the viewing state of the distributed video content, whereby the learning unit 136 optimizes the insertion reference point or the number of seconds of the insertion of the advertisement.

Furthermore, in the course of the learning process, regarding the number of times of distribution at a predetermined rate, the learning unit 136 may also perform a process of distributing the video content in which the advertisement insertion points are randomly decided. For example, if the advertisement insertion points with respect to the entire video content are decided on the basis of the predetermined insertion reference points, there may be a case in which the learning unit 136 is not able to obtain an opportunity to detect an optimum advertisement insertion point. Consequently, regarding the decision of the advertisement insertion points of the video content, the learning unit 136 may also perform a process of randomly deciding the advertisement insertion points regarding the predetermined rate. Furthermore, in the learning process, various kinds of known technologies may also be used.

4. Flow of a Process

In the following, the flow of a process performed by the decision device 100 according to the embodiment will be described with reference to FIGS. 7 to 9. First, the flow of a process of deciding advertisement insertion points with respect to the submitted video content will be described with reference to FIG. 7. FIG. 7 is a flowchart (1) illustrating the flow of a process performed by the decision device 100 according to the embodiment.

As illustrated in FIG. 7, the submission accepting unit 131 accepts the submission of the video content (Step S101). Then, the acquiring unit 132 acquires the feature information on the video content (Step S102). Subsequently, the decision unit 133 decides the advertisement insertion points of the video content on the basis of the feature information on the video content (Step S103).

If the decision unit 133 decides the advertisement insertion points, the decision unit 133 associates the advertisement insertion points with the video content and stores the decided advertisement insertion points in the storage unit 120 (Step S104).

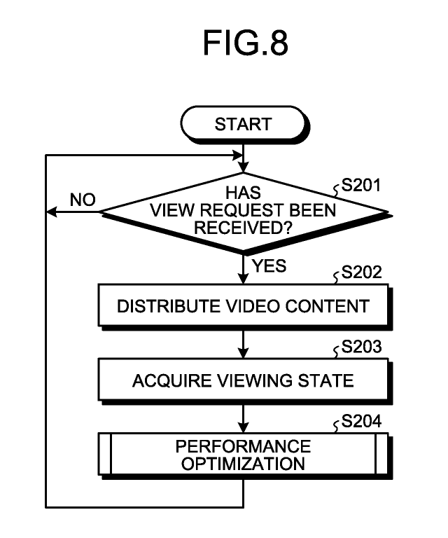

In the following, the flow of a process performed when the decision device 100 distributes the video content will be described with reference to FIG. 8. FIG. 8 is a flowchart (2) illustrating the flow of a process performed by the decision device 100 according to the embodiment.

The reception unit 134 determines whether a view request (distribution request) for the video content in the video distribution site has been received from a user (Step S201). If the view request has not been received (No at Step S201), the reception unit 134 waits until the reception unit 134 receives the view request.

In contrast, if the view request has been received (Yes at Step S201), in response to the view request, the distribution unit 135 distributes the video content (Step S202). Then, the acquiring unit 132 acquires the viewing state in the user terminal 10 (Step S203). Subsequently, the learning unit 136 performs an optimization process on the advertisement insertion points (Step S204).

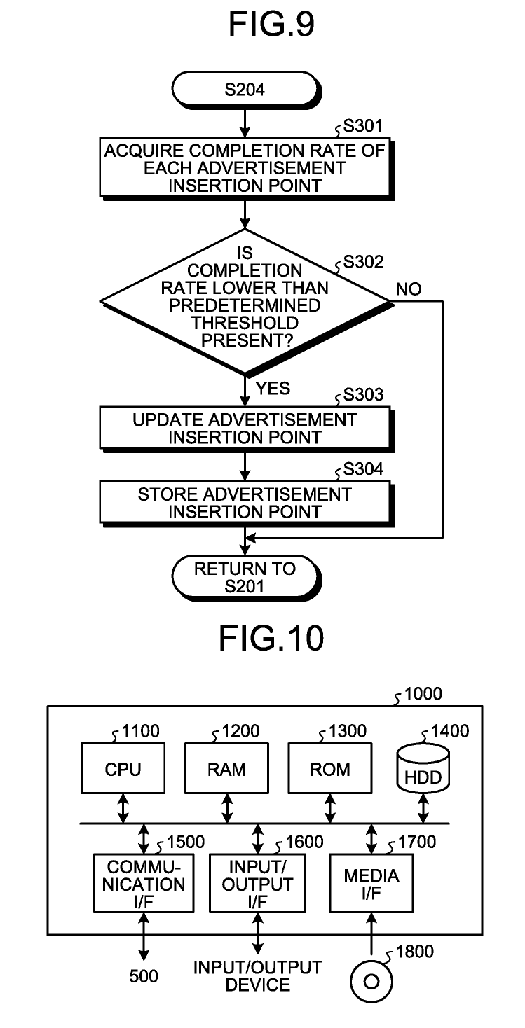

In the following, the optimization process will be described. FIG. 9 is a flowchart (3) illustrating the flow of a process performed by the decision device 100 according to the embodiment.

First, the acquiring unit 132 acquires the completion rate of each of the advertisement insertion points in the video content (Step S301). Then, the learning unit 136 determines whether the completion rate that is lower than the predetermined threshold (Step S302).

If the completion rate that is lower than the predetermined threshold is present (Yes at Step S302), the decision unit 133 updates the advertisement insertion points on the basis of the insertion reference point or the like learned by the learning unit 136 (Step S303). Then, the decision unit 133 stores the advertisement insertion points included in the video content at this time (Step S304).

In contrast, if the completion rate that is lower than the predetermined threshold is not present (No at Step S302) and if the advertisement insertion point are updated, the decision unit 133 ends the process.

5. Modification

The decision device 100 described above may also be performed with various kinds of embodiments other than the embodiment described above. Therefore, another embodiment of the decision device 100 will be described below.

5-1. Advertisement Time with Respect to the Video Content

The decision device 100 may also previously acquire the rate of advertisement time with respect to the video content and may also decide, on the basis of the obtained information, advertisement insertion points and the advertisement time of each of the advertisement insertion points. For example, the decision device 100 may also set 8% or 10% of the playback time of the video content to the total time of the advertisement to be inserted in the video content.

Then, the decision device 100 decides the advertisement time of each of the advertisement insertion points on the basis of the previously set total time of the advertisement to be inserted in the video content. Consequently, the decision device 100 can implement advertisement distribution in response to an administrator of the video distribution service of the desire of an advertiser.

5-2. Setting of the Advertisement Time

In the embodiment described above, an example has been described in which the decision device 100 decides to set the advertisement time to be inserted at the advertisement insertion point to “15 seconds”. However, the advertisement to be actually inserted at the advertisement insertion point does not always need to be set in accordance with the subject time. The period of time of the advertisement held by the advertisement server 30 is not limited to 15 seconds but may also be the period of time of 20 seconds or 25 seconds. Consequently, even if the decision device 100 decides to set the advertisement time at the advertisement insertion point to “15 seconds”, the decision device 100 may also set some allowance such that various kinds of advertisements can be inserted.

5-3. Insertion of an Advertisement

In the embodiment described above, an example has been described in which, because the advertisement distribution request inserted in the video content is sent to the advertisement server 30, an advertisement is distributed from the advertisement server 30 to the user terminal 10. However, the advertisement may also previously be associated with the video content and distributed to the user terminal 10.

In this case, when a user selects the video content that is desired by the user to view in the video distribution site, the decision device 100 accepts the distribution of the advertisement from the advertisement server 30. Then, the decision device 100 combines the advertisement insertion point of the video content with the advertisement accepted by the advertisement server 30. Then, the decision device 100 distributes the video content combined with the advertisement to the user terminal 10.

In also this method, by acquiring the viewing state of the video content from the user terminal 10, the decision device 100 can acquire the information indicating which one of the advertisements has been played back (displayed) or completed.

5-4. Video Distribution Site

In the embodiment described above, an example has been described in which the decision device 100 provides the video distribution site. However, the video distribution site itself may also be provided by a web server that is different from the decision device 100. In this case, the decision device 100 distributes, to the web server in accordance with a request sent from the subject web server, the data on the video content in which the advertisement insertion points have been decided or the setting information on the advertisement insertion points with respect to the video content. The web server that provides the video distribution site distributes, to the user terminal 10, the video content that includes the advertisement insertion points determined by the decision device 100.

Furthermore, the service provided by the video content is not always limited to the video distribution site. For example, the video content may also be distributed from a video image distribution application that functions in a smart device. Namely, the video content that includes the advertisement insertion points decided by the decision device 100 may also be distributed by any device.

5-5. Acquisition of the Viewing State

As described above, the acquiring unit 132 can acquire the information indicating how long a user has viewed video content or an advertisement and which time point the user deviated from the video content or the advertisement. Consequently, in addition to use the start of the view of the advertisement of the completion rate as the index value, the learning unit 136 may also evaluate the customer appeal of the advertisement in accordance with the viewing time of the advertisement. Furthermore, the acquiring unit 132 may also acquire the residence time for which the line of the sight of the user stayed at the advertisement by using the eye tracking method that analyzes the motion of the line of the sight of the user in the video distribution site. In this way, the acquiring unit 132 can acquire various kinds of information as the information related to the viewing state.

5-6. Acquisition of the User Information

In the embodiment described above, an example has been described in which the acquiring unit 132 acquires the user information at the time when the user terminal 10 accesses the video distribution site that is provided by the decision device 100. However, the acquiring unit 132 also sometimes acquires the user information from the user terminal 10, in addition to a case in which the user terminal 10 accesses the video distribution site provided by the decision device 100. This point will be described below.

For example, if the video distribution site accessed by the user terminal 10 is provided from a predetermined web server that is managed by the same management device as the management device (for example, a front end server with respect to the decision device 100) that manages the decision device 100, the acquiring unit 132 can acquire the user information from the user terminal 10. Namely, when the user terminal 10 accesses the video distribution site provided by the predetermined web server that is managed by the management device, the user terminal 10 sends the user information on the user terminal 10 to the management device described above. This is implemented by the user terminal 10 sending a cookie to the management device. In this case, the user information sent by the user terminal 10 is sent to the decision device 100 via the management device. Consequently, the acquiring unit 132 according to the decision device 100 can acquire the user information on the user terminal 10 without using the decision device 100. Furthermore, the acquiring unit 132 can identify each of the user terminals 10 by checking the cookie described above or the device ID that is previously set in the user terminal 10.

5-7. User Layer

In the embodiment described above, the decision device 100 may also classify the index value of the advertisement effect on the basis of the attribute information on a user. Namely, the decision device 100 may also classify the user by “age”, “gender”, or the like and may also learn the maximum rate of the completion of an advertisement, the position of the advertisement insertion point that is likely to be completed, or the like. Furthermore, the decision device 100 may also decide the advertisement insertion point on the basis of the operation performed by a user. For example, the decision device 100 acquires the operation information on the operation in which the video content is paused by the user. The position of the video content that is likely to be paused by the user is the position for the user without causing an uncomfortable feeling even if an advertisement is inserted. In this case, the decision device 100 decides, as the advertisement insertion point, the position in which the video content is likely paused by the user. In this way, the decision device 100 may also decide the advertisement insertion point on the basis of the operation information having a significant tendency from among the pieces of the operation information on the user.

5-8. Advertisement Effect

Regarding the viewing state of each of the advertisement insertion points, the decision device 100 may also acquire the viewing state for each distributed advertisement. Namely, the state of the completion performed by a user is sometimes influenced by not only the insertion point of the advertisement inserted in the video content or the advertisement time but also by the content of an advertisement itself. By acquiring the viewing state for each distributed advertisement, the decision device 100 can analyze the state, such as the completion rate being widely dispersed due to the advertisement or the completion rate being widely dispersed due to the advertisement insertion point.

5-9. Insertion of an Advertisement Based on Time

In the embodiment described above, an example has been described in which the decision device 100 decides the advertisement insertion points on the basis of the entire rate of the playback time of the video content. However, the decision device 100 may also decide the advertisement insertion points on the basis of the time information on the playback position of the video content.

Namely, the decision device 100 acquires the information indicating that the advertisement insertion points are created in a predetermined time period of the video content. For example, the decision device 100 may also decide to create the advertisement insertion points regarding each of the ranges, such as the beginning of the video content (within 3 minutes from the playback starting point), the playback position of “15 to 18 minutes” from the video content, and the playback position “30 to 35 minutes” from the video content.

Furthermore, the decision device 100 may also acquire the time information described above for each length of the entire playback time of the video content or for each category of the video content. As described above, in the video content, an appropriate position of the advertisement insertion point sometimes varies in accordance with the entire length of the category. Consequently, for example, if the category is a “drama”, the decision device 100 decides the advertisement insertion point on the basis of the time information described above, whereas, if the category is “animation”, the decision device 100 may also decide the advertisement insertion point on the basis of different time information.

5-10. Adjustment of Playback

Furthermore, when the decision device 100 sets the advertisement insertion point, in addition to the timing in which an advertisement is inserted, the decision device 100 may also decide the timing in which the playback of the video content is resumed.

Namely, if the playback of the video content is resumed after the advertisement is inserted, instead of starting the playback at the position in which an advertisement is inserted, resuming the playback by returning the playback position by the predetermined time period is sometimes desirable for a viewing user. In this case, the overlapped position in the video content is played back in the predetermined time period.

Furthermore, when the decision device 100 resumes the video content by returning the playback position by an amount corresponding to the predetermined time period, the decision device 100 may also resume the sound volume of the video content from the state lower than the normal state. Consequently, because the decision device 100 can resume the video content in a natural flow manner after the advertisement is inserted, whereby the decision device 100 can improve the usability.

Furthermore, the decision device 100 may also decide, on the basis of the feature information on the video content, whether the video content is resumed by returning the playback position by an amount corresponding to the predetermined time period. For example, the decision device 100 decides, on the basis of the category of the video content, whether the video content is resumed by returning the playback position by an amount corresponding to the predetermined time period. For example, if the category of the video content is a “drama” or “variety”, the decision device 100 may also resume the video content by returning (overlapping) the playback position by an amount corresponding to the predetermined time period. In contrast, if the category of the video content is a “sport”, the decision device 100 may also resume the video content without returning the playback position by an amount corresponding to the predetermined time period. In this way, the decision device 100 may also appropriately and flexibly adjust the playback position in accordance with the category or the content of the video content.

6. Hardware Configuration

The decision device 100, the user terminal 10, the submission terminal 20, and the advertisement server 30 according to the embodiment described above are implemented by, for example, a computer 1000 having the configuration illustrated in FIG. 10. In the following, a description will be given by using the decision device 100 as an example. FIG. 10 is a block diagram illustrating an example of the hardware configuration of the computer 1000 that implements the function performed by the decision device 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 is operated on the basis of the programs stored in the ROM 1300 or the HDD 1400 and performs control of each unit. The ROM 1300 stores therein a boot program that is executed by the CPU 1100 at the time of a startup of the computer 1000, a program that depends on the hardware of the computer 1000, or the like.

The HDD 1400 stores therein the programs executed by the CPU 1100, data used by the subject programs, and the like. The communication interface 1500 receives data from another device via a communication network 500 (corresponds to the network N illustrated in FIG. 2), sends the received data to the CPU 1100, and sends the data created by the CPU 1100 to another device via the communication network 500.

The CPU 1100 controls, via the input/output interface 1600, an output device, such as a display, a printer, or the like, and controls an input device, such as a keyboard, a mouse, or the like. The CPU 1100 acquires data from the input device via the input/output interface 1600. Furthermore, the CPU 1100 outputs the data created via the input/output interface 1600 to the output device.

The media interface 1700 reads the program or data stored in a recording medium 1800 and provides the read program or data to the CPU 1100 via the RAM 1200. The CPU 1100 loads, via the media interface 1700, the subject program from the recording medium 1800 into the RAM 1200 and executes the loaded program. The recording medium 1800 is, for example, an optical recording medium, such as a digital versatile disc (DVD), a phase change rewritable disk (PD), or the like, a magneto optical recording medium, such as a magneto-optical disk (MO), or the like, a tape medium, a magnetic recording medium, a semiconductor memory, or the like.

For example, when the computer 1000 functions as the decision device 100 according to the embodiment, the CPU 1100 in the computer 1000 implements the function of the control unit 130 by executing the program loaded into the RAM 1200. Furthermore, the HDD 1400 stores therein data in the storage unit 120. The CPU 1100 in the computer 1000 reads the programs from the recording medium 1800; however, as another example, the programs may also be acquired from another device via the communication network 500.

7. Others

Of the processes described in the embodiment, the all or a part of the processes that are mentioned as being automatically performed can also be manually performed, or the all or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the decision unit 133 and the learning unit 136 illustrated in FIG. 3 may also be integrated. Furthermore, for example, the information stored in the storage unit 120 may also be stored in an external storage device via the network N.

Furthermore, for example, in the embodiment described above, an example has been described in which the decision device 100 performs an acceptance process of accepting the submission of the video content, a decision process of deciding the timing in which an advertisement is inserted, and a distribution process of distributing the video content. However, the decision device 100 described above may also be separated into an acceptance device that performs the acceptance process, a decision device that performs the decision process, and a distribution device that performs the distribution process. In this case, the acceptance device includes at least the submission accepting unit 131. Furthermore, the decision device includes at least the decision unit 133. Furthermore, the distribution device includes at least the distribution unit 135. In this case, the processes performed by the decision device 100 are implemented by a decision system 1 that includes devices of the reception device, the decision device, and the distribution device.

Furthermore, the above-described embodiments and modifications may be combined appropriately as long as the processes do not conflict with each other.

8. Effects

As described above, the decision device 100 according to the embodiment includes the acquiring unit 132 and the decision unit 133. The acquiring unit 132 acquires the length of the playback time of the video content as the feature information included in the video content that is provided by the network. On the basis of the length of the playback time acquired by the acquiring unit 132, the decision unit 133 decides the timing in which an advertisement is inserted in the video content.

In this way, the decision device 100 according to the embodiment decides the advertisement insertion points on the basis of, for example, the entire playback time of the video content as the feature information on the video content. Consequently, even for a large amount of video content in which various kinds of playback time are present in a mixed manner, the decision device 100 can insert advertisements in the video content at appropriate playback positions without taking a trouble, such as manually deciding the advertisement insertion points.

Furthermore, in addition to the timing in which an advertisement is inserted in the video content, the decision unit 133 decides, for each of the timings, the playback time of the advertisement to be inserted.

In this way, the decision device 100 according to the embodiment may also decide the playback time of the advertisement for each advertisement insertion point. For example, the decision device 100 can flexibly insert an advertisement by lengthening the advertisement time for the advertisement insertion point that is viewed with relatively high probability and shortening the advertisement time for the other points.

Furthermore, the acquiring unit 132 acquires, as the feature information, the category of the video content. The decision unit 133 decides, on the basis of the category acquired by the acquiring unit 132, the timing in which an advertisement is inserted in the video content.

In this way, the decision device 100 according to the embodiment may also decide the advertisement insertion points on the basis of the category. In the video content, because the structure of the video image varies in accordance with the category, the position appropriate for inserting an advertisement sometimes differs. The decision device 100 decides the advertisement insertion points on the basis not only the playback time but also the category, whereby the decision device 100 can insert an advertisement at an appropriate position of the video content.

Furthermore, the acquiring unit 132 acquires the setting information that is associated with both the playback time of the video content and the category of the video content and that serves as the standard of the timing in which an advertisement is inserted in the video content. The decision unit 133 decides, on the basis of the setting information acquired by the acquiring unit 132, the timing in which the advertisement is inserted in the video content.

In this way, the decision device 100 according to the embodiment previously acquires the setting information that is associated with both the playback time and the category and checks the playback time and the category against the setting information, thereby deciding the advertisement insertion points. The decision device 100 acquires the standard, such as an advertisement insertion point being created which position in the video content; therefore, decision device 100 can skip the basic setting, such as how many advertisement insertion points to be created, the way of setting of the playback time of an advertisement, or the like. Furthermore, by referring to the setting information, the decision device 100 can insert an advertisement in accordance with an intention of an administrator of the video distribution site who has set the setting information, an administrator of the advertisement server 30, an advertiser, or the like.

Furthermore, the acquiring unit 132 acquires, as the feature information, the information related to the soundtrack of the video content. The decision unit 133 decides, on the basis of the information related to the soundtrack of the video content, the timing in which an advertisement is inserted in the video content.

In this way, the decision device 100 according to the embodiment may also decide the advertisement insertion point on the basis of the sound of the video content. For example, the decision device 100 creates an advertisement insertion point at a mute position of the video content. Consequently, the decision device 100 can insert the advertisement at the position for a viewing user without causing an uncomfortable feeling.

Furthermore, the decision unit 133 decides the timing in which an advertisement is inserted in the video content on the basis of the playback position that is stored in the information related to the soundtrack of the video content and in which a state of sound volume lower than a predetermined threshold is continued in a predetermined time period.

In this way, the decision device 100 according to the embodiment creates the advertisement insertion point on the basis of the state of the sound volume of the video content. Consequently, the decision device 100 can set, in the video content, the advertisement insertion point at the position in which the scene is assumed to reach a breakpoint instead of setting the advertisement insertion point at a singular point, such as a brief moment of a muted point. Consequently, the decision device 100 can insert an advertisement at the position for a viewing user without causing an uncomfortable feeling. Furthermore, the decision device 100 does not need to set the playback position in which a state of low sound volume is continued in the predetermined time period to the advertisement insertion point. For example, the decision device 100 may also set, to the advertisement insertion point, the position immediately before the playback position in which the state of low sound volume is continued in the predetermined time period or the position immediately after the playback position in which the state of low sound volume is continued in the predetermined time period.

Furthermore, the acquiring unit 132 acquires the information related to a change in a scene in the video content as the feature information. The decision unit 133 decides the timing in which an advertisement is inserted in the video content on the basis of the information related to a change in a scene in the video content. Specifically, the acquiring unit 132 acquires the information related to the pixels of the video image constituting the video content as the information related to a change in the scene in the video content. Then, the decision unit 133 decides the timing in which the advertisement is to be inserted in the video content on the basis of the information related to the pixels of the video image constituting the video content.

In this way, the decision device 100 according to the embodiment may also decide the advertisement insertion point on the basis of the information related to a change in a scene. For example, on the basis of the pixel information on the video content, the decision device 100 creates an advertisement insertion point at the position in which the video content becomes darker or brighter. Consequently, the decision device 100 can insert the advertisement at the position for a viewing user without causing an uncomfortable feeling.

Furthermore, regarding the video content in which the timing of the insertion of the advertisement is decided by the decision unit 133, the acquiring unit 132 acquires the viewing state of the user who has viewed the subject video content. The decision unit 133 updates the timing in which the advertisement is inserted in the subject video content on the basis of the viewing state acquired by the acquiring unit 132.

In this way, the decision device 100 according to the embodiment can acquire the viewing state of the video content in which the advertisement insertion points have been decided and update the advertisement insertion points by reflecting the viewing state. Namely, by performing the learning process, the decision device 100 updates the advertisement insertion points at the position in which the effect of the advertisements is easily exhibited. Consequently, the decision device 100 can improve the advertisement effect of the advertisements that are inserted in the video content.

Furthermore, if the completion rate, included in the viewing state, of the advertisement inserted in the video content is lower than the predetermined threshold, the decision unit 133 changes the timing in which the advertisement has been inserted and newly decides the timing in which the advertisement is inserted in the subject video content.

In this way, the decision device 100 according to the embodiment changes the advertisement insertion points on the basis of the completion rate of the advertisement. If the completion rate of the advertisement is low, the advertisement insertion points created in the video content are assumed to be inappropriate in some way. By changing the advertisement insertion points on the basis of the completion rate, the decision device 100 can decide the advertisement insertion points that are assumed to be more appropriate for a user.

Furthermore, the decision unit 133 decides the timing in which an advertisement is inserted in the video content and also decides the timing in which a playback of the video content is resumed at the time when the advertisement is inserted in the video content. Specifically, the decision unit 133 decides the timing that is before the timing in which the advertisement is inserted in the video content by a predetermined time period as the timing in which the playback of the video content is resumed at the time when the advertisement is inserted in the video content.

In this way, the decision device 100 according to the embodiment may also decide the timing of the resumption of the video content such that the playback time of the video content is resumed, after the advertisement has been inserted in the video content, by returning by an amount corresponding to the predetermined time period. Namely, if the advertisement has been inserted, the decision device 100 decides the playback point of the resumption such that the video content is overlapped by an amount corresponding to the predetermined time period. Consequently, because the decision device 100 can prevent an abrupt start of the playback from the breakpoint of the video content, the decision device 100 can improve the usability of a user who uses the video distribution site.

Furthermore, on the basis of the feature information on the video content, the decision unit 133 decides the timing in which the playback of the video content is resumed at the time when the advertisement is inserted in the video content between the timing that is before the timing in which the advertisement is inserted in the video content by the predetermined time period and the timing that is the same timing as the timing in which the advertisement is inserted in the video content.

In this way, the decision device 100 according to the embodiment can decide whether an overlapped playback is to be performed in accordance with the feature information on the video content. For example, the decision device 100 decides whether an overlapped playback is to be performed in accordance with the category or the content of the video content. For example, the viewing style, such as an overlapped playback being desirable for a user who views a drama, or an overlapped playback not being desirable for a user who views a sport, of a user varies depending on the category of the video content. According to the decision device 100, it is possible to provide the video content in accordance with the viewing style of a user who views the video content.

Furthermore, when the decision unit 133 decides the timing in which the playback of the video content is resumed, in the timing in which the playback of the video content is resumed, the decision unit 133 sets the sound volume at the time when the playback is resumed to the sound volume that is lower than the sound volume at the time when the playback of the video content is continued.

In this way, the decision device 100 according to the embodiment may also resume the sound volume of the video content from the state lower than the normal state. Consequently, the decision device 100 the decision device 100 can resume the video content in a natural flow manner after the advertisement is inserted. For example, the decision device 100 can suppress the state in which the video content abruptly starts in the middle of the conversation or is suddenly resumed with a loud sound volume. In this case, the decision device 100 may also add an adjustment of the sound volume to the video content such that the setting (fade-in) in which the sound volume is gradually returned to the normal sound volume from the low volume. Consequently, the decision device 100 can improve the usability of a user who views the video content.

Furthermore, the “components (sections, modules, units)” described above can be read as “means”, “circuits”, or the like. For example, the acquiring unit can be read as acquiring means or an acquiring circuit.

The above-described embodiment can be applied not only to a decision device, a decision method, and a decision program but also to a decision device for switching a digital data packet stream. The decision device for switching a digital data packet stream according to the present application includes an acquiring unit (corresponding to acquiring unit 132) acquires, as feature information associated with a first digital data packet stream that is transmitted via an information and telecommunications network, the length of playback time in a case where the digital data packet stream is played back by rendering at a standard playback rate, and a decision unit (corresponding to decision unit 133) decides, on the basis of the length of the playback time acquired by the acquiring unit, a time position in which a playback target is switched temporarily from the first digital data packet stream to a second digital data packet stream.

The decision device for switching a digital data packet stream can be applied not only to a video advertisement but also to other technical fields such as optimization of a music program, control of a behavior of a robot, and an emergency announcement. “The decision device that includes an acquiring unit acquires, as feature information included in video content that is provided via a network, the length of playback time of the video content, and a decision unit decides, on the basis of the length of the playback time acquired by the acquiring unit, a timing in which an advertisement is inserted in the video content” can be performed alone without requiring a configuration “The decision device for switching a digital data packet stream that includes an acquiring unit acquires, as feature information associated with a first digital data packet stream that is transmitted via an information and telecommunications network, the length of playback time in a case where the digital data packet stream is played back by rendering at a standard playback rate, and a decision unit decides, on the basis of the length of the playback time acquired by the acquiring unit, a time position in which a playback target is switched temporarily from the first digital data packet stream to a second digital data packet stream”.

According to an aspect of an embodiment, an advantage is provided in that it is possible to insert an advertisement at an appropriate playback position in video content.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A decision device comprising:
an acquiring unit that acquires, as feature information associated with a first digital data packet stream that is transmitted via an information and telecommunications network, the length of playback time in a case where the digital data packet stream is played back by rendering at a standard playback rate; and
a decision unit that decides, on the basis of the length of the playback time acquired by the acquiring unit, a time position in which a playback target is switched temporarily from the first digital data packet stream to a second digital data packet stream.

2. The decision device according to claim 1, wherein
the acquiring unit acquires, as feature information included in video content that is provided via a network, the length of playback time of the video content; and
the decision unit decides, on the basis of the length of the playback time acquired by the acquiring unit, a timing in which an advertisement is inserted in the video content.

3. The decision device according to claim 2, wherein
the decision unit decides, for each of the timings in addition to the timing in which the advertisement is inserted in the video content, the playback time of the advertisement that is inserted.

4. The decision device according to claim 2, wherein
the acquiring unit acquires, as the feature information, a category of the video content, and
the decision unit decides, on the basis of the category acquired by the acquiring unit, the timing in which the advertisement is inserted in the video content.

5. The decision device according to claim 4, wherein
the acquiring unit acquires setting information that is associated with both the playback time of the video content and the category of the video content and that serves as the standard of the timing in which the advertisement is inserted in the video content, and
the decision unit decides, on the basis of the setting information acquired by the acquiring unit, the timing in which the advertisement is inserted in the video content.

6. The decision device according to claim 2, wherein
the acquiring unit acquires, as the feature information, information related to a soundtrack of the video content, and
the decision unit decides, on the basis of the information related to the soundtrack of the video content, the timing in which the advertisement is inserted in the video content.

7. The decision device according to claim 6, wherein
the decision unit decides, on the basis of a playback position that is included in the information related to the soundtrack of the video content and in which a sound volume lower than a predetermined threshold is continued in a predetermined time period, the timing in which the advertisement is inserted in the video content.

8. The decision device according to claim 2, wherein
the acquiring unit acquires, as the feature information, information related to a change in a scene in the video content, and
the decision unit decides, on the basis of the information related to the change in the scene in the video content, the timing in which the advertisement is inserted in the video content.

9. The decision device according to claim 8, wherein
the acquiring unit acquires, as the information related to the change in the scene, information related to pixels of a video image constituting the video content, and
the decision unit decides, on the basis of the information related to the pixels of the video image constituting the video content, the timing in which the advertisement is inserted in the video content.

10. The decision device according to claim 2, wherein
the acquiring unit acquires, regarding the video content in which the timing of the insertion of the advertisement has been decided by the decision unit, a viewing state of a user who has viewed the video content, and
the decision unit updates, on the basis of the viewing state acquired by the acquiring unit, the timing in which the advertisement is inserted in the video content.

11. The decision device according to claim 10, wherein,
when the completion rate, which is included in the viewing state, of the advertisement inserted in the video content is lower than a predetermined threshold, the decision unit changes the timing in which the advertisement has been inserted and newly decides the timing in which the advertisement is inserted in the video content.

12. The decision device according to claim 2, wherein
the decision unit decides the timing in which the advertisement is inserted in the video content and decides the timing in which a playback of the video content is resumed at the time when the advertisement has been inserted in the video content.

13. The decision device according to claim 12, wherein
the decision unit decides the timing that is before the timing in which the advertisement is inserted in the video content by a predetermined time period as the timing in which the playback of the video content is resumed at the time when the advertisement has been inserted in the video content.

14. The decision device according to claim 12, wherein
the decision unit decides, on the basis of the feature information on the video content, the timing in which the playback of the video content has been resumed at the time when the advertisement is inserted in the video content between the timing that is before the timing in which the advertisement is inserted in the video content by a predetermined time period and the timing that is the same timing as the timing in which the advertisement is inserted in the video content.

15. The decision device according to claim 12, wherein,
when the decision unit decides the timing in which the playback of the video content is resumed, in the timing in which the playback of the video content is resumed, the decision unit sets the sound volume at the time when the playback is resumed to a sound volume that is lower than the sound volume at the time when the playback of the video content is continued.

16. A method performed by a computer, the method comprising:
acquiring, as feature information included in video content that is provided via a network, the length of playback time of the video content; and
deciding, on the basis of the length of the playback time acquired at the acquiring, a timing in which an advertisement is inserted in the video content.

17. A non-transitory computer readable storage medium having stored therein a computer program causing a computer to execute a process comprising:
acquiring, as feature information included in video content that is provided via a network, the length of playback time of the video content; and
deciding, on the basis of the length of the playback time acquired at the acquiring, a timing in which an advertisement is inserted in the video content.
